(19) United States
(12) Patent Application Publication
(10) Pub. No.: US 2012/0243826 A1
(43) Pub. Date: Sep. 27, 2012

(54) LOW POWER COMPACT OPTICAL SWITCH

(76) Inventors: Liping Sun, Kanata (CA); Shaochun Cao, Kanata (CA); Michel Savoie, Stittsville (CA)

(21) Appl. No.: 13/052,461

(22) Filed: Mar. 21, 2011

(51) Int. Cl. G02B 6/35

(52) U.S. Cl. 385/17; 385/18

(57) ABSTRACT

The invention relates to optical waveguide switches wherein input light propagating in an input waveguide may be switched between two output waveguides by means of a carrier-induced total internal reflection. The switches utilizes a double-reflection, or, generally, a multiple-reflection electrode to reduce the light deflection angle at each reflection interface, thereby enabling to increase the light switching angle and/or decrease the power consumption of the switch.

### TECHNICAL FIELD

The present invention relates to optical switches, and in particular to optical waveguide switches having an electrode at a waveguide branching point for switching the direction of light propagation by applying an electrical signal to the electrode.

### BACKGROUND OF THE INVENTION

Fast optical switching is an important enabler of advanced optical networks, in particular such functions as routing burst and packet optical signals, optical path provisioning and fault restoration. Semiconductor digital optical switches (DOSs) can fulfill such high speed applications due to their nanosecond switching times, step-like switching responses, and robustness to variations in temperature, wavelength, polarization, refractive index and device fabrication tolerances. Moreover, semiconductor optical switches offer potential for integration with other semiconductor components, both optical and electronic, and thus promise considerable savings in the size, complexity and cost of an overall optical system.

For optical waveguide switches, fast optical switching may be achieved by a refractive index change, induced either by carrier injection or by the electro-optic effect, within III-V semiconductors, such as GaAs-based and InP-based. Compared to carrier-injection switches, electro-optic switches have faster switching speeds but larger switching voltages since the refractive index change induced by the electro-optic effect is about two orders of magnitude smaller than the refractive index change induced by carrier injection.

Therefore, so far most of the commercially available semiconductor DOS products have been based on carrier-injection. These devices typically utilize carrier-induced total internal reflection (TIR) at a waveguide branching or crossing point to switch the light path from one waveguide to another. Such TIR-based switches typically require a large index modulation, e.g. in the order of 0.01 or greater, with the region of changed index having a well-defined boundary. Accordingly, efforts have been made to restrict current spreading and to confine the injected carriers to the desired region. Typically, achieving such carrier confinement involves using relatively complex semiconductor device technologies, such as ion implantation, electron-beam lithography, Zn diffusion, and epitaxial regrowth. Examples of prior-art semiconductor DOSs using carrier injection for switching are disclosed in U.S. Pat. Nos. 6,891,986, 7,200,290, 7,317,848, 7,689,069, all of which are incorporated herein by reference.

FIG. 1 illustrates a plane view of a typical prior-art semiconductor DOS 10, wherein two waveguides 11 and 12 intersect at an angle θ forming an X-like waveguide structure. An electrode 30 is provided over a common waveguide region 15 where the waveguides 11 and 12 intersect for injecting carriers into a portion of the common region 15 to decrease its refractive index n by an amount Δn sufficient to induce TIR for the input beam 21 and to cause it to turn by the angle θ to propagate along the waveguide 12, forming switched light 23. In the absence of the carrier injection, i.e. when there is no current flowing through the electrode 30, the input light 21 continues its propagation along the waveguide 11 past the common region 15 to form the transmitted light 22. In order to switch the input light 21 into the waveguide 12, the electrode 30 is positioned so that its edge 31, which faces the input light 21, crosses the waveguide 11 at an angle θ/2 thereto, bisecting the waveguide crossing region.

One drawback of the design of FIG. 1 is that, for optimal performance, the electrode 30 should be positioned with its ‘receiving’ edge 31 centered in the common waveguide region 15. This makes the structure asymmetrical with respect to the waveguides 11 and 12, so that the switch 10 is, essentially, a ‘Y’ switch that can only function as a 1×2 switch and not as a 2×2 switch.

B. Li and S. J. Chua, in an publication entitled “2×2 optical waveguide switch with bow-tie electrode based on carrier-injection total internal reflection in SiGe alloy,” IEEE Photon. Technol. Lett., 13, 206-208, 2001, which is incorporated herein by reference, disclosed a 2×2 switch using a bow-tie electrode. This switch is schematically illustrated in FIG. 2; it has a similar waveguide topology as switch 10, but utilizes the bow-tie electrode 33 in place of the straight electrode 30 of FIG. 1. The apex 35 of the bow-tie electrode 33, i.e. its narrowest point, is located at the central point of the waveguide intersection, and the electrode 33 is symmetrical with respect to all four waveguide ends. The switch disclosed by Li and Chua has a switching angle 37 θ=2°, and the electrode bow-tie angle 39 of 1.5 degrees. The switch utilizes ion implantation about the electrode 33 to decrease current spreading and confine the injected carriers.

One disadvantage of the prior art semiconductor switches is that they are limited to small switching angles, or equivalently a small waveguide crossing angle, typically about 2° or less for a 2×2 switch, and 4° or less for a 1×2 switch. The small switching angle increases the size of the device and limits the integration density. Another disadvantage of the prior art TIR semiconductor switches is their relatively large power consumption, especially for devices with the switching angle at the higher end of the range, as such devices require larger electrical currents. It is therefore desirable to develop TIR switches with greater light switching angles and/or reduced power consumption.

Accordingly, there exists a need for an improved semiconductor optical switch. This invention addresses this need in the art as well as other needs, which will become apparent to those skilled in the art from this disclosure.

### SUMMARY OF THE INVENTION

The present invention relates to optical waveguide switches having a multi-reflection switching electrode for reducing the change in the waveguide refractive index that is required for switching the direction of propagation of input light by a given angle.

One aspect of the invention provides an optical switch, comprising: a) a waveguide structure comprising a first input waveguide for guiding input light, first and second output waveguides for guiding transmitted light and switched light, respectively, and a waveguide branching region optically coupling said three waveguides, wherein the first input waveguide is optically aligned with the first output waveguide and is oriented at a light switching angle with respect to the second output waveguide; and, b) a switching electrode disposed over a portion of the waveguide branching region for inducing a refractive index change therein by carrier injection so as to direct the input light towards the second output waveguide in the presence of the carrier injection by means of reflection, and for transmitting the input light through the waveguide brunching region into the first output waveguide in the absence of the carrier injection. The switching electrode is shaped so that, in the presence of the carrier injection, most of the input light experiences multiple reflections in the waveguide branching region prior to being directed into the second output waveguide.

According to an aspect of the present invention, the switching electrode has a first edge facing the first input waveguide and a second edge, wherein the first edge is positioned for turning, in the presence of the carrier injection, the input light by a first deflection angle for directing thereof generally towards the second edge as first reflected light, wherein the first deflection angle is less than the light switching angle. The second edge is positioned for turning, in the presence of the carrier injection, the first reflected light by a second deflection angle towards the second output waveguide for forming the switched light, wherein the second angle is less than the light switching angle.

According to one feature of the present invention, each of the first and second deflection angles is equal or less than a half of the light switching angle, and the first edge is oriented relative to the second edge at an electrode edge angle θₑ that is equal or less than one half of the waveguide switch angle θ.

### BRIEF DESCRIPTION OF THE DRAWINGS

The invention will be described in greater detail with reference to the accompanying drawings which represent preferred embodiments thereof, in which like elements are indicated with like reference numerals, and wherein:

FIG. 1 is a schematic plain view of a prior art TIR switch with a straight electrode;

FIG. 2 is a schematic plain view of a prior art TIR switch with a bow-tie electrode;

FIG. 3 is a schematic plain view of a 1×2 optical switch with a multi-reflection electrode according to an embodiment of the present invention;

FIG. 4 is a schematic plain view of a 1×2 optical switch with a curved multi-reflection electrode according to an embodiment of the present invention;

FIG. 5 is a schematic diagram illustrating reflection of the input light at a double-reflection electrode;

FIG. 6 is a schematic plain view of a 2×2 optical switch with a multi-reflection electrode according to an embodiment of the present invention;

FIG. 7 is a schematic plain view of a waveguide structure of the 2×2 optical switch of FIG. 6;

FIG. 8A is a schematic cross-sectional view of the ridge structure of the 2×2 optical switch of FIG. 6 taken along the line A-A;

FIG. 8B is a diagram schematically illustrating the optical mode, the current flow region and the reflective interface induced by the carrier injection in the cross-sectional view of FIG. 8A;

FIG. 9 is a schematic diagram showing the waveguide layer structure according to an embodiment of the present invention;

FIG. 10 is a schematic plain view of a 2×2 optical switch with cosine waveguide bends and the multi-reflection electrode of FIG. 6;

FIG. 11 is a schematic plain view of a 1×2 optical switch with cosine waveguide bends and the multi-reflection electrode of FIG. 4;

FIG. 12 is a schematic diagram illustrating reflection of the input light at a multi-reflection electrode with four reflection edges.

### DETAILED DESCRIPTION

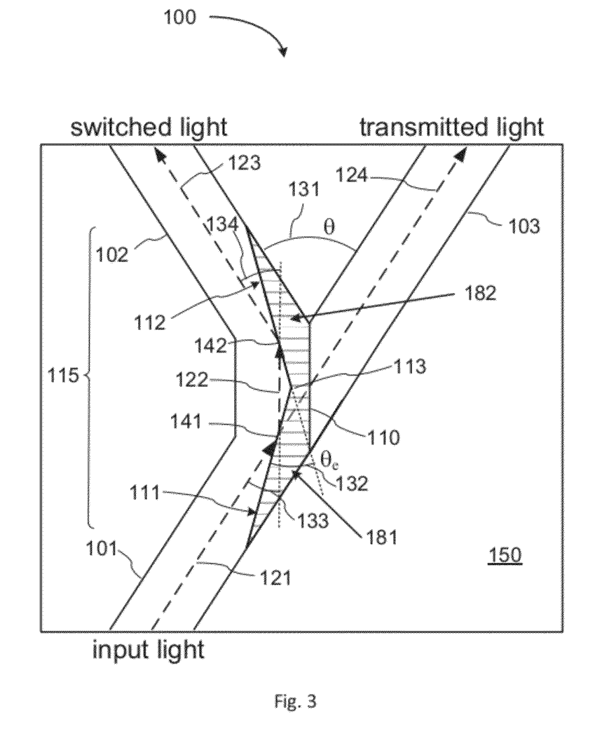

With reference to FIG. 3, there is illustrated, in a plane view, an optical switching structure (OSS) 100 employing a double-reflection electrode geometry according to an embodiment of the present invention. In the shown embodiment the OSS 100 utilizes a ‘Y’-shaped waveguide structure that is well known in the art. It has an input waveguide 101, hereinafter also referred to as the first input waveguide, a first output waveguide 103, and a second output waveguide 102. A waveguide branching region 115 optically couples the first input waveguide 101 to one of the output waveguides 102 and 103. At the waveguide branching region 115, the second output waveguide 102 is oriented at angle θ 131 with respect to the first output waveguide 103 and the first input waveguide 101. The angle 131 θ is referred to herein as the branching angle, crossing angle or light switching angle. The waveguide branching region 115 may be viewed as, or includes, a common, or shared, portion of the input and output waveguides 101-103. The waveguides 101-103 are formed in, or upon, a semiconductor substrate or wafer 150.

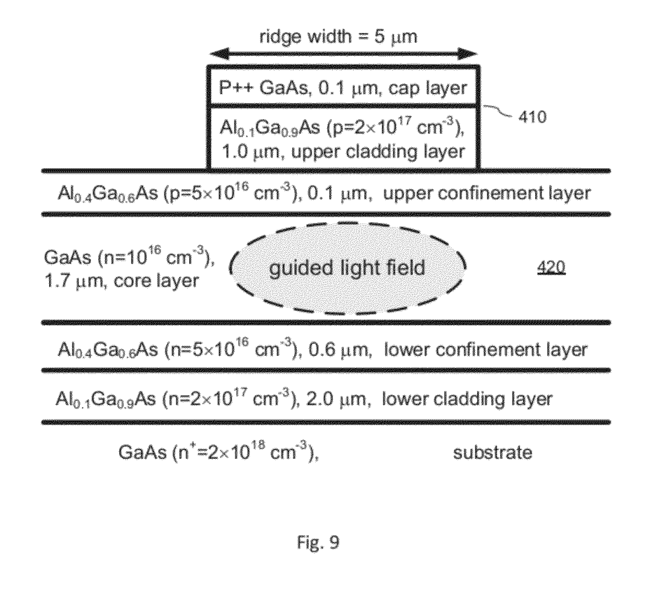

Techniques for forming optical waveguides in semiconductor materials are well known in the art and will not be described here. In one embodiments, the waveguides 101-103 are ridge waveguides. In other embodiments, the waveguides may be buried waveguides and may be fabricated using re-growth or other suitable technique as known in the art. Examples of suitable semiconductor materials for the substrate 150 include III-V materials such as GaAs and InP based, SiGe heterostructures and alike. FIG. 9 illustrates an exemplary waveguide layer structure of the OSS 100, with a ridge 410 formed over a waveguiding layer 420, and is described in further detail hereinbelow.

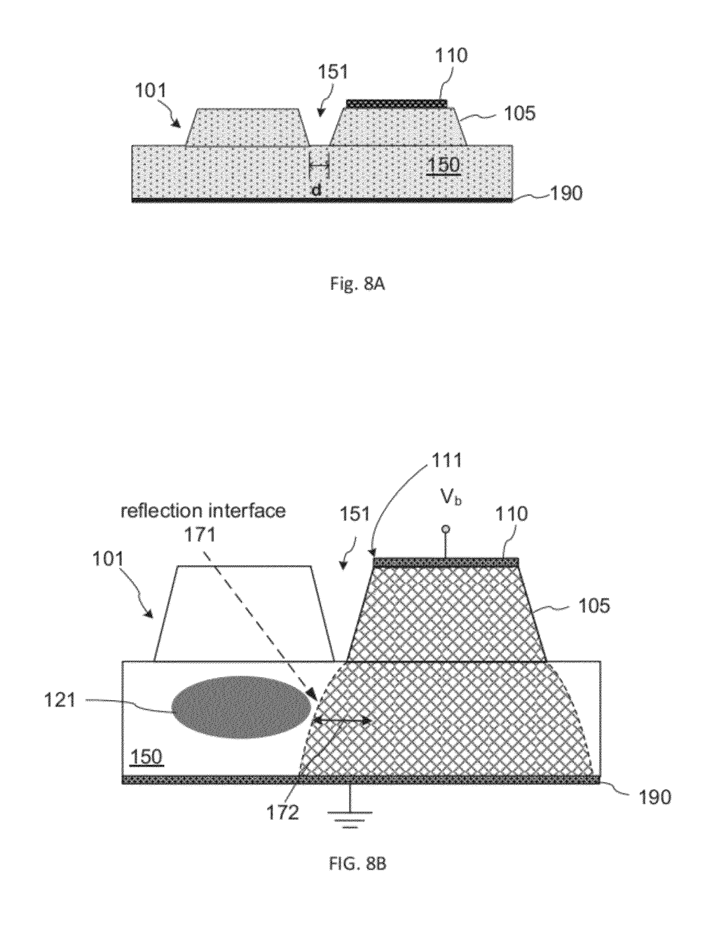

An electrode 110, which is also referred to herein as the switching electrode, is disposed over a portion of the branching region 115. By applying a suitable electrical voltage V_{b} to the switching electrode 110, carriers of an electrical charge may be injected into a portion of the waveguide branching region 115 underneath the electrode 110, thereby reducing its refractive index n as known in the art. The region of the waveguide structure wherein the carrier concentration is changed due to the carrier injection is referred to herein as the index change region. The boundary of that region substantially follows, in the plane of the substrate 150, the edges of the electrode 110, possibly with a slight offset due to current spreading and carrier diffusion, as described hereinbelow with reference to FIG. 8B. This boundary is also referred to herein as the reflection interface. In the following, we will denote the refractive index change required to induce TIR at the boundary of the index change region as Δn.

The input waveguide 101 and the first output waveguide 103 are optically aligned. In the absence of the carrier injection through the electrode 110, input light 121, which enters the OSS 100 by means of the input waveguide 101, traverses the waveguide branching region 115 and is coupled into the first output waveguide 103 as transmitted light 124. In the presence of the carrier injection, the electrode 110 induces the refractive index change Δn in the waveguide regions underneath it, thereby directing the input light 121 to couple into the second output waveguide 102 by means of reflection. The input light 121 that reached the second output waveguide 102 is referred to herein as the switched light 123.

In accordance to a feature of the present invention, the electrode 110 is shaped to induce double reflection of the input light 121. For that purpose, in the shown embodiment the electrode 110 can be viewed as composed of two section 181 and 182 having a first edge 111 and a second edge 112, respectively; these edges will also be referred to herein as the reflection edges of the electrode 110. The first edge 111 faces the first input waveguide 101 and is positioned for turning, in the presence of the carrier injection, the input light 121 by a first deflection angle θ₁ 133, so as to form first reflected light 122 that propagates generally towards the second edge 112.

The second edge 112 is positioned for turning, in the presence of the carrier injection, the first reflected light 122 by a second angle θ₂ 134 towards the second output waveguide 102 for coupling thereinto as the switched light 123.

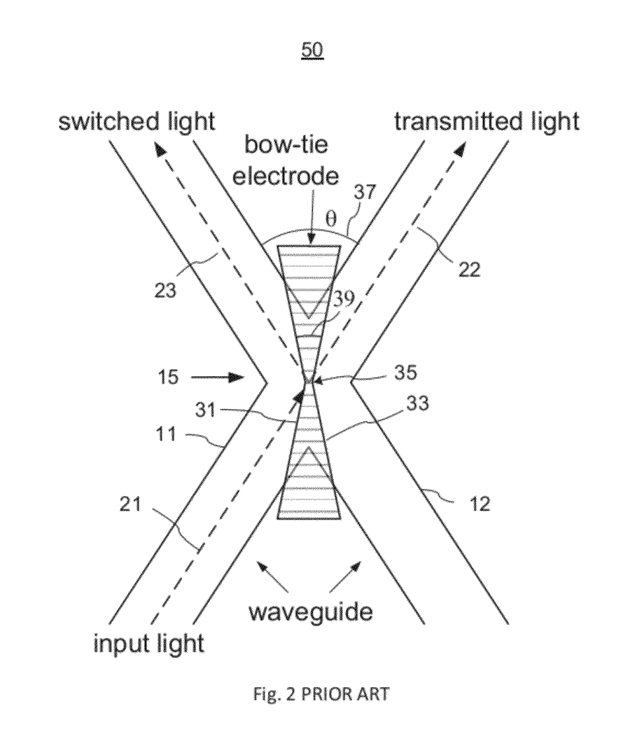

According to a feature of the present invention, the electrode 110 is shaped and positioned so that, in the absence of the carrier injection, substantially all or at least most of the input light 121, for example more than 80% or preferably at least 90% or greater, passes under the first edge 111 of the electrode 110. Advantageously, this results in that in the presence of the carrier injection through the electrode 110, substantially all or at least most of the input light 121 may be reflected at the first edge 111. Note that this feature differentiates the electrode 110 of the OSS 100 from the prior art bow-tie electrode of FIG. 2 as disclosed by Li and Chua. Indeed, in the switch of FIG. 2 the input light impinges upon two inclined edges of the bow-tie electrode 33, or the waveguide regions thereunder, in substantially equal portions. Consequently, only about half of the input light passes under the lower bow-tie edge that is oriented at a smaller grazing angle, resulting in a loss of input light, since the other half of the input light that reaches the upper edge of the bow-tie electrode 33 may not be reflected under TIR due to its increased grazing angle at the upper edge of the bow-tie electrode. Here, “lower” or “upper” refers to a relative position of a respective feature in the figure.

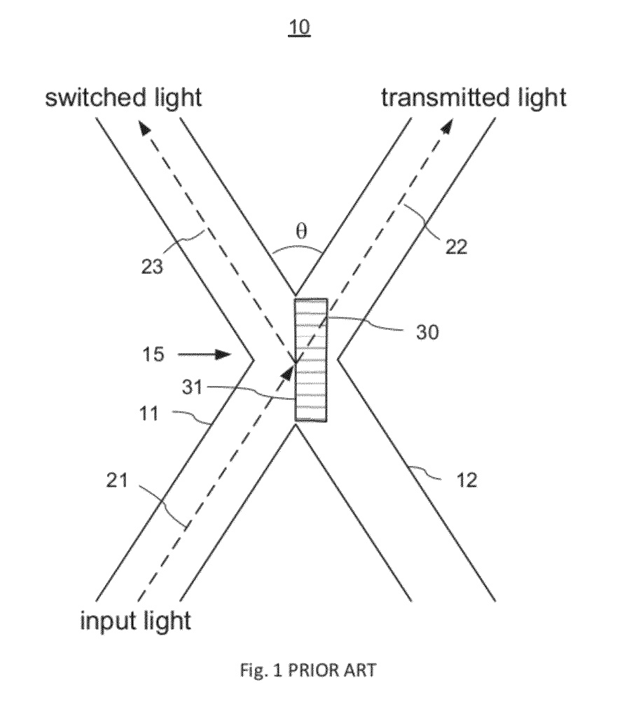

Continuing to refer to FIG. 3, in a further advantage each of the first and second deflection angles 133, 134 is less than the light switching angle θ, and therefore the switching of the input light's direction by the switching angle θ may be accomplished by a smaller refractive index change Δn under the electrode 110, and thus using a smaller injection current than would have been required for the conventional single-reflection electrode design such as that of FIG. 1. For the double-reflection electrode configuration illustrated in FIG. 3, the first and second edges 111, 112 are oriented so that the sum of the first and second deflection angles 133, 134 is equal to the waveguide branching angle 131 θ:

θ₂+θ₁=θ (1)

In one currently preferred embodiment, the first and second angles 133, 134 are both equal to one half of the branching angle 131 θ:

θ₂=θ₁=θ/2 (2)

Advantageously, this enables to have the switching angle 133 twice as large as in the conventional single-reflection design for a same refractive index change Δn in the index change region, or, alternatively, to turn the light by the same angle θ using only half of the electrical current density. Indeed, the reflective index change Δn that is required to induce the TIR at the first and second edges 111, 112 may be estimated from an approximate TIR condition

θᵢ≦Δn/n, i=1, 2, (3)

which approximately holds for Δn/n 1 and the angles θᵢ measured in radians, so that reducing the turning angle of TIR by a factor of 2 reduces the required index change by a same factor.

Continuing to refer to FIG. 3, the electrode edges 111 and 112 are shown as straight lines that intersect at an apex point 113 forming an acute angle 132. This angle 132 will be denoted herein as θₑ and referred to as the electrode edge angle, or simply as the electrode angle. According to an aspect of the present invention, the electrode edge angle θₑ is equal to one half of the waveguide branching angle θ in the double-reflection embodiment, i.e.

θₑ=θ/2. (4)

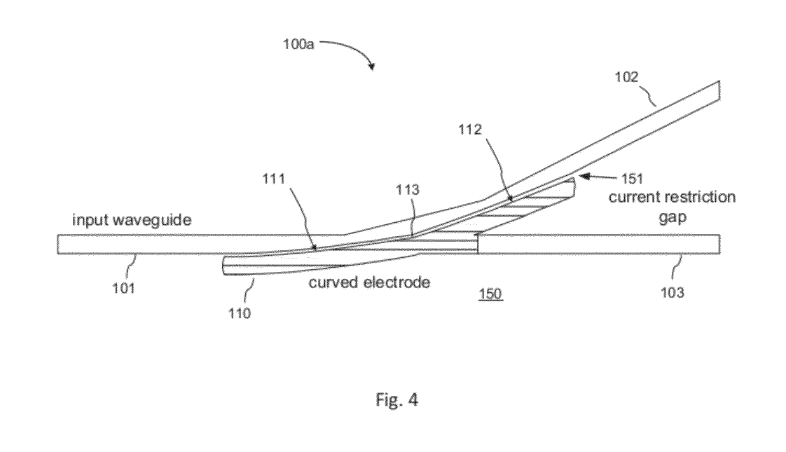

The present invention also encompasses embodiments wherein one or both of the electrode edges 111, 112 are curved. One such embodiment is illustrated in FIG. 4, which shows an OSS 100a that is generally similar to the OSS 100 of FIG. 3, but wherein the edges 111 and 112 of the electrode 110 are curved, and are outlined by a gap 151 formed in the waveguide branching region to restrict the current from spreading. In embodiments with curved electrodes, the edges 111 and 112 may intersect at an angle that is less than θ/2, or generally less than θ/N wherein N is the number of reflection edges of the multi-reflection electrode 110, and the apex 113 of the electrode 110 where the edges meet may not be easily discernable. Note that embodiments wherein the edges 111 and 112 are disconnected by a small gap would also be within the scope of the present invention.

Electrodes with curved edges are known in the art. For example, an article by H. Hatami-Hanza, J. Nayyer and S. Satani-Naeins, entitled “Extinction ratios and scattering losses of optical intersecting waveguide switches with curved electrodes,” Journal of Lightwave Technology, vol. 12, pp 1475-1481, August 1994, which is incorporated herein by reference, discloses a curved electrode in a waveguide switch with an electrode curvature in the form of a logarithmic spiral. Other shapes of the electrode edges 111, 112, such as, but not exclusively, edges following a cosine function, are also possible within the scope of the present invention. The use of the electrode gap has been described in an article by L. Sun, J. Noad, R. James, D. Coulas, S. Cao, G. Lovell, and E. Higgins, entitled “Novel Large Cross-Section Single-Mode AlGaAs/GaAs Asymmetric Optical Switch Based on Carrier Injection Effect”, Proceeding of SPIE, vol. 5595, pp 439-446, 2004, which is incorporated herein by reference.

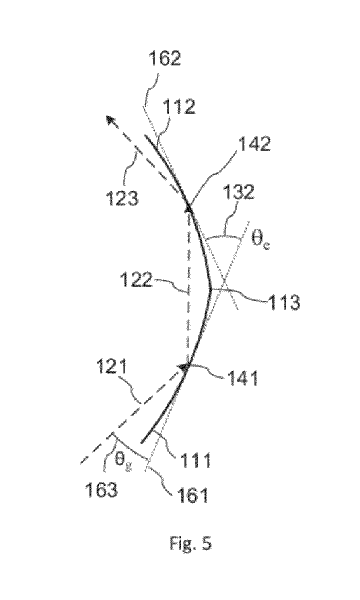

According to an aspect of the present invention, equation (4) also relates to the curved edges of the electrode 110 in double-reflection embodiments, when the electrode edge angle θₑ is suitably defined. First, we note that the direction and optical path of the guided light may be defined by its central ray. Accordingly, the input light 121, the first reflected light 122, and the second reflected light 123 are each represented in FIG. 3 by their respective central rays, or equivalently by optical paths thereof, which may also be referred to herein using respective labels ‘121’ to ‘123’. For example, the input light 121 is represented in FIG. 3 by a dashed line labeled ‘121’ schematically illustrating an optical trajectory of the central ray of the input light propagating in the input waveguide 101. Similarly, a dashed line labeled ‘122’, that represents in FIG. 3 the first reflected light 122, schematically shows an optical trajectory of the central ray of the first reflected light. Referring now to FIG. 5, which schematically illustrates a zoom-in view of the curved electrode edges 111, 112 in relation to the central rays 121 and 122, the electrode edge angle θₑ may be defined as the acute angle 132 between tangents 161, 162 to the first and second electrode edges 111, 112 at points 141, 142 of reflection of the central rays of the input light 121 and the first reflected light 122. Here, ‘tangent’ or ‘tangent line’ refers to a straight line that touches a curve at a particular location without intersecting it. According to one exemplary embodiment of the present invention, the so defined electrode edge angle θₑ satisfies equation (4).

According to another feature of this embodiment of the present invention, a grazing angle θ_{g} 163 of the input beam to the electrode edge 111 is about one half of the first deflection angle θ₁, and about one quarter of the waveguide crossing angle θ, i.e.

θ_{g}=θ/4. (5)

For the curved electrodes, the grazing angle θ_{g} 163 may be defined as the angle between the central ray of the input beam 121 and the tangent 161 to the electrode edge 111 at the first reflection point 141.

The equality in equations (2), (4), (5) and other similar equations in the present specification, should be understood as approximate, subject to manufacturing tolerances and device layout optimizations that may take into account, for example, the current spreading and carrier diffusion effects, and encompasses deviations within +\−25% of respective angles. Particular embodiments may benefit from tighter angular tolerances, wherein the grazing angle θ_{g}, the electrode angle θₑ, and the deflection angles θ_{1,2} satisfy equations (5), (4) and (2), respectively, with a tolerance of +\−10%.

Note that the prior-art bow-tie electrode 33 of FIG. 2, as taught by Li and Chua, has the bow-tie angle 39 and the waveguide branching angle 37 equal to 1.5° and 2°, respectively, and therefore does not satisfy equation (4). Accordingly, condition (4) further differentiates the aforedescribed embodiment of the present invention from the prior art.

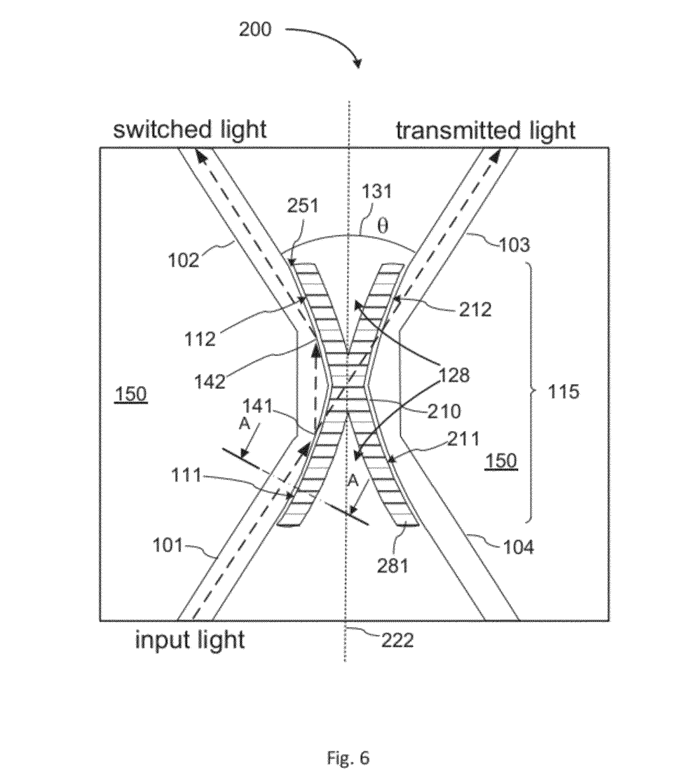

With reference to FIG. 6, the double-reflection electrode geometry that has been described hereinabove with reference to FIGS. 3-5 for 1×2 optical switches can be adopted for 2×2 switches, such as the OSS 200 schematically shown in the figure, by adding a second input waveguide 104 and by symmetrically extending the double-reflection electrode 110 so as to form a switching electrode 210 additionally having a second pair of electrode edges 211 and 212 for switching light from the second input waveguide 104 into the first output waveguide 103 by means of double reflection at the third electrode edge 211 and the forth electrode edge 212. In the OSS 200, the second input waveguide 104 is optically aligned with the second output waveguide 102 so that, in the absence of the carrier injection through the electrode 210, input light from the second input waveguide will be transmitted by the branching section 115 into the second output waveguide 102. In the presence of the carrier injection, light that enters the OSS 200 from the second input waveguide 104 experiences two consecutive reflections at the third and fourth edges 211, 212, each time turning by the deflection angle θ/2 in one embodiment, and is directed into the first output waveguide 103, while light that enters the OSS 200 from the first input waveguide 101 experiences two consecutive reflections at the first and second edges 111, 112 and is directed into the second output waveguide 102 as described hereinabove with reference to FIG. 3. The waveguide and electrode edge structure of the OSS 200 is substantially symmetrical with respect to an axis of symmetry 222 which bisects the waveguide crossing angle 131.

In the embodiment shown in FIG. 6, the electrode 210 is shaped as an ‘X’, with two cut-outs 128 about the symmetry line 222 in the input and output portions of the structure, so as to reduce scattering optical loss and the total electrical current required for the switching, and therefore to reduce the power consumption and device heating. Other embodiments may employ differing electrode shapes, as long as the ‘outward’ edges of the electrode 210 are shaped to induce multiple reflections of the input light in the presence of the carrier injection from the electrode.

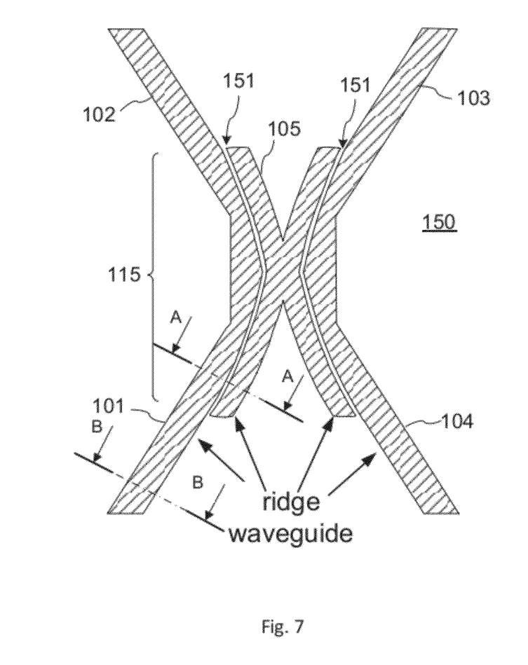

With reference to FIG. 7, there is illustrated, in a plane view, a ridge waveguide structure of the OSS 200, without the electrode 210, according to one embodiment of the invention. In the waveguide branching region 115, it includes an X-shaped ridge 105 upon which the electrode 210 is disposed. The electrode gaps 151 outlining the reflection edges 111, 112, 211 and 212 of the electrode 210 may be formed by etching to restrict the current spread into the waveguide regions not covered by the electrode 210, and to obtain a sharp carrier gradient profile for improved switching efficiency. FIG. 8A schematically illustrates a cross-section of the ridge waveguide structure of the OSS 200 along the line ‘A-A’ shown in FIGS. 6 and 7. FIG. 8B further schematically illustrates the current restriction effect of the electrode gap 151. It also schematically shows an effective reflection interface 171 wherein the reflection of the guided light 121 occurs in the presence of the carrier injection. When the switching voltage V_{b} is applied between the switching electrode 110 and a metal contact 190, which is formed here on an opposite side of the substrate 150 but may also formed for lateral injection as known in the art, the switching electrical current flows through the current flow region indicated by cross-hatching. Although the gap 151 substantially reduces the current spread into the regions not directly under the switching electrode 110, it does not eliminate the spreading completely, resulting in a possibility of a small lateral offset 172 of the effective reflection interface 171 from the reflection edge 111 of the electrode 110 in the plane of the substrate 150. This offset however may be rather small, for example on the order of less than 1 μm, and is substantially smaller than the size of the waveguide branching region, so that for the purposes of the present specification the light reflection that occurs at the reflection interface 171 is referred to as the reflection at the closest electrode's edge, in the shown example the first reflection edge 111.

With reference to FIG. 9, there is illustrated by way of example one possible layer structure of the waveguides of the OSS 100, 100a and 200, for example as viewed in a vertical cross-section of the device along the line ‘B-B’ shown in FIG. 7. This layer structure has been used by the inventors of the present invention to fabricate prototype units of the OSS 100a and OSS 200, and has been described by Liping Sun, Shaochun Cao, and Michel Savoie, in “Novel 2×2 Wide-Angle AlGaAs/GaAs Carrier-Injection Optical Switch with Reduced Power Consumption”, OFC 2010 paper 8E1-4, Mar. 21-25 2010, San Diego, USA, and in “Novel 1×2 Double-Reflection AlGaAs/GaAs Carrier-Injection Optical Switch”, OECC 2010, Jul. 5-9 2010, Sapporo, Japan, which are incorporated herein by reference. In this exemplary embodiment, the waveguide structure has six AlGaAs/GaAs layers grown by MOCVD on an n+ GaAs substrate 150. For a single-mode waveguide at a wavelength of the input light of 1.55 microns (μm), the ridge width of 5.0 μm was used, with the ridge height of about 1 μm. A waveguide core layer 420 of GaAs is 1.7 μm thick, and is, to the best of our knowledge, the largest ever reported for a single-mode semiconductor DOS. It provides high coupling efficiency to a single mode fibre. The GaAs waveguide core layer 420 is lightly doped, n=10¹⁶ cm⁻³, to provide an optimized trade-off between low propagation loss and low switching voltage. In order to reduce energy band discontinuities at the heterojunctions that would impede the current flow therethrough, and to reduce the switching voltage, compositionally graded interfaces 20 nm-40 nm thick were used at all the layer interfaces. As we reported in an article by L. Sun, J. Noad, R. James, D. Coulas, S. Cao, G. Lovell, and E. Higgins, entitled “Low-loss, low-voltage, AlGaAs/GaAs high speed optical switch with doping and composition graded heterojunction interfaces”, Proc. SPIE, vol. 6469, pp. 64690Q1-64690Q9, 2007, which is incorporated herein by reference, the effect of using graded heterojunctions in reducing the switching voltage is quite significant. The width of the electrode gap d, as illustrated in FIG. 8A, is about 1 μm. These gaps may be formed using a double mask technique to overcome photolithography problems when forming small gaps. With this technique, two masking stripes, which are independently defined in separate lithographic steps, can also be used as masks in a dry etch process to obtain ridge waveguides with small isolation trenches 151.

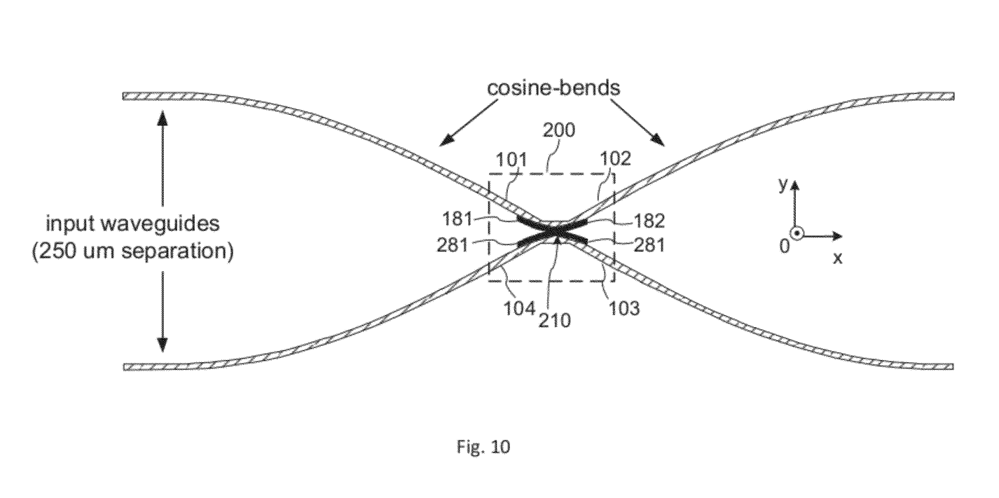

Based on this waveguide layer structure, we have fabricated a prototype 2×2 carrier-injection optical switch, which is illustrated in FIG. 10, and which is based on the double-reflection OSS 200 illustrated in FIG. 6. The fabricated optical switch has the two input waveguides 101, 104 and two output waveguides 102, 103 extended with curved waveguide sections embodied as cosine bends, with a functional form [h/2−(h/2)cos(πx/l)], where h is the height of the bend, l is the length of the bend, and x is the horizontal propagation length. The device further included a top contact pad that is not shown in the figure, to provide an electrical contact to the switching electrode 110 as known in the art. To reduce the crosstalk at the waveguide crossing, adiabatic tapers are used in the waveguide branching region. The switch electrode 210 included four segments 181, 182, 281 and 282, each curved in a logarithmic spiral shape instead of the conventional straight electrode to provide high power reflectivity, high extinction ratio, and low scattering loss. Advantageously, the fabrication processes only employ conventional technologies, such as UV photolithography, e-beam evaporation and plasma etching. Independently formed electrode and photoresist layers were used as a double-mask in a single dry etch process to form the ridge waveguides 101-105 and gaps 151. Uniform gap spacing was obtained using Vernier alignment marks with ±0.1 μm alignment accuracy. The switch had an electrode length of 550 μm, a waveguide crossing angle θ of 7°, and a cosine-bend section of 6.4 mm.

Measured propagation losses of straight waveguides with undoped and lightly doped core layers were 0.3 dB/cm and 1.5 dB/cm, respectively, for a wavelength of 1.55 μm. The switched state was obtained for an injection current of 220 mA. At this state, the driving voltage was 2.89 V and the measured device series resistance was 9.8Ω, resulting in a total power dissipation at a manageable level of 0.6 W. With the area of the fabricated electrode being 3400 μm², the corresponding switching current density was 6.5 kA/cm². By using this current density and assuming a 10 ns carrier lifetime, the estimated carrier density and Δn are about 2×10¹⁸ cm⁻³ and −0.02, respectively. Such a high index change may be the result of a long carrier lifetime in the thick core layer, and/or a decrease in the current spreading at high current densities, which results in current “bunching” in the core below the isolation gap and hence yields better power reflectivity. The measured switching time was 15 ns. On-off extinction ratio is 13 dB for the through port and 14 dB for the switched port. The switch is wavelength independent for a wavelength range from 1540 nm to 1570 nm. A very small polarization dependence of TE and TM modes has been observed (<0.5 dB). The measured extra insertion loss of the 2×2 switch compared with the straight waveguide fabricated on the same chip is 3 dB.

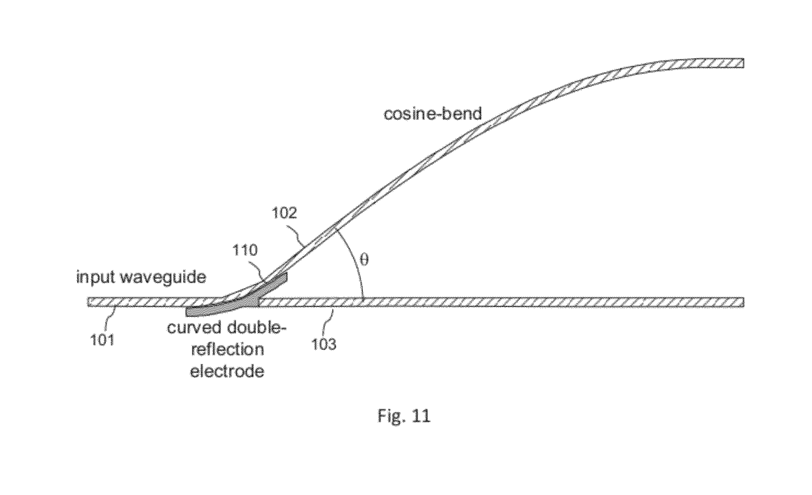

A prototype 1×2 optical switch with the double-reflection electrode as shown in FIGS. 3, 4 and the waveguide ridge structure of FIG. 9 was also fabricated using same fabrication technology. The fabricated device is illustrated in FIG. 11. The fabricated switch has an electrode length of 480 μm, and a waveguide crossing angle of 6°. The measured propagation losses of straight waveguides with undoped and lightly doped core layers are 0.3 dB/cm and 1.5 dB/cm, respectively, for a wavelength of 1.55 μm. The measured extra insertion loss of the 1×2 switch compared with the straight waveguide fabricated on the same chip is 2 dB. The switched state was obtained for an injection current of 105 mA at a bias of 2.30 V. The total power dissipation was 0.24 W and no extra cooling is required to keep the switched state. The on-off extinction ratio is 15 dB for the through port and 14 dB for the switched port. The switch is wavelength independent for the measured C-band. The polarization dependence of TE and TM mode input lights has been found to be less than 0.5 dB. The measured switching time is 11 ns which is close to the carrier lifetime in bulk materials. It can be smaller if the core layer thickness is reduced, but the fibre coupling efficiency will decrease.

Advantageously, the aforedescribed double-reflection, or generally multi-reflection, switching that is used in the present invention addresses important drawbacks of the prior art TIR-bases optical switches. For example, in prior art 2×2 switches that use conventional straight electrode design as shown in FIG. 1, in order to reduce an optical axis misalignment of the reflected light for both input ports, the electrode 30 has to be narrow; disadvantageously, a narrow electrode will generally result in a poor reflectivity induced by the current passing through the electrode, leading to a degradation of the switch extinction ratio, i.e. the optical power ratio for the output ports. One disadvantage of the prior-art bow-tie electrode design shown in FIG. 2, is that its electrode 33 is still narrow at the waveguide crossing point 35, potentially enabling the light 21 to leak therethrough even under the carrier injection condition. Furthermore, a part of the incoming light 21 that incidents on the top electrode segment may be refracted rather than reflected because of the increased grazing angle. All these may limit the light switching angle θ of the bow-tie type 2×2 switches to about 2° in real device applications.

Advantageously, the optical switching structures described hereinabove with reference to FIGS. 3-11 address these deficiencies of the prior art, enabling optical switching at greater waveguide crossing angles θ and/or smaller induced refractive index changes, and thus smaller power consumption. In one advantageous aspect, the double-reflection, or, generally, multiple-reflection electrode structure eliminates the optical misalignment problem and electrode width problems of the straight and bow-tie electrodes in the 2×2 switching configurations. With the double-reflection electrode configuration, the light incident at the first electrode edge is deflected, by means of TIR, by a half of the light switching angle θ toward the second electrode edge, which further deflects the light by another half of the switch crossing angle toward the ‘switched’ output port. As a result, at the same light switching angle, the index change Δn, and hence the injection current density that is required by the TIR condition, needs to be only half of that of the prior art “single reflection” switches, thereby reducing the injection current density by half for a same light switching angle θ. On the other hand, if the same switching current density is to be used with the multi-reflection electrode of the present invention as in the prior art TIR-bases switches, the light switching angle can be doubled, making the overall device more compact and thus allowing more devices to be integrated on the wafer.

One potential disadvantage of the aforedescribed multi-reflection switch configuration is that, for the same light switching angle θ, the overall area of the switch electrode 110 may be as much as two times larger than that of the prior art single-reflection electrodes, which may partially negate the effect of the reduced current density upon the total power consumption of the device; the larger electrode area and a relatively more complex waveguide branching area may also lead to an increase in the scattering optical loss in the waveguide branching region. Advantageously, these two potentially deleterious effects decrease dramatically by increasing the switch crossing angle θ, and may be reduced to an acceptable level at least for θ greater than about 3-4°.

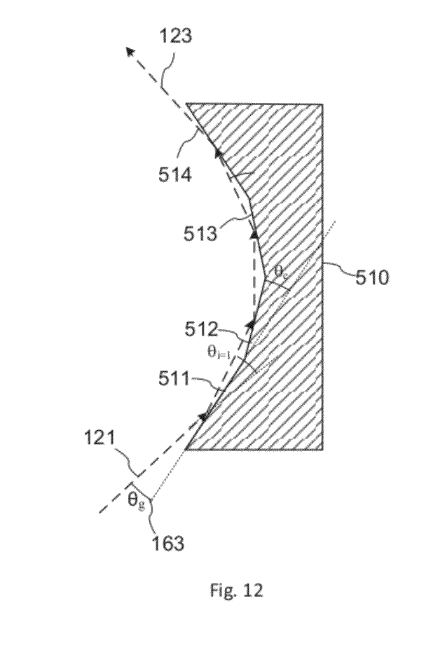

The invention has been described hereinabove with reference to specific embodiments, which are not meant to be limiting and are described by way of example only; various other embodiments, and modifications to the described embodiments will become apparent to those skilled in the art having from the present description. For example, although the invention has been described hereinabove with reference to electrodes that induce double reflection in the waveguide branching region, switch electrodes that are shaped to induce a greater number of reflections of the input light can be easily envisioned. FIG. 12 illustrates by way of example a multi-reflection electrode 510 that is shaped so that it has four reflection edges 511-514, so that in the presence of the carrier injection, the input light 121 is sequentially reflected at each of these edges to eventually, after the fourth reflection, to form the switched light 123 that propagates at the switch crossing angle θ with respect to the input light 121. At each of the four edges 511-514, the light is reflected, by means of the TIR at the index change region underneath, at an i^{th} deflection angle θᵢ that is substantially smaller than the switch angle θ. For example, each of the deflection angles θᵢ, i=1, . . . , 4 and the electrode edge angle θₑ may be one fourth of the switch crossing angle θ. For an electrode having N≧2 reflection edges, the electrode should be such that the first deflection angle θ₁ is equal or less than θ/2, and in one embodiment equal to about θ/N, and the electrode edge angle θₑ is also equal or less than θ/2, and in one embodiment equal to about θ/N, wherein the electrode edge angle θₑ is defined as an angle between tangents to the electrode at locations of the first and second reflections of the central ray of the input light. In another aspect, the grazing angle 163 θ_{g} of the input light 121 to the electrode edge should be equal or less than one quarter of the switch crossing angle θ, i.e. θ_{g}≦θ/4, and in one embodiment equal to about θ/(2N), where the grazing angle θ_{g} is defined as the angle between the central ray of the input light beam 121, or the direction of the input beam propagation, and the tangent to the electrode 110 at the point of first reflection. A switching electrode having N=2 reflection edges has been demonstrated in our exemplary embodiments described hereinabove. For a given application, using an electrode having N>2 reflection edges may require balancing a trade-off between reflection times N, optical axis misalignment, scattering optical loss in the waveguide branching region, and ensuring that most of the input light is reflected at each edge.

Other embodiments and modifications of the embodiments described herein are also possible and will be apparent to those skilled in the art from the present specification.

We claim:

1. An optical switch, comprising:
a substrate;
a waveguide structure formed in the substrate comprising a first input waveguide for guiding input light, first and second output waveguides for guiding transmitted light and switched light, respectively, and a waveguide branching region optically coupling said three waveguides, wherein the first input waveguide is optically aligned with the first output waveguide and is oriented at a light switching angle with respect to the second output waveguide; and,
a switching electrode disposed over a portion of the waveguide branching region for inducing a refractive index change therein by carrier injection so as to direct the input light towards the second output waveguide in the presence of the carrier injection by means of reflection, and for transmitting the input light through the waveguide brunching region into the first output waveguide in the absence of the carrier injection;
wherein the switching electrode is shaped so that, in the presence of the carrier injection, most of the input light experiences multiple reflections in the waveguide branching region prior to being directed into the second output waveguide.

2. An optical switch of claim 1, wherein the switching electrode has a first edge facing the first input waveguide and a second edge, and wherein
the first edge is positioned for turning, in the presence of the carrier injection, the input light by a first deflection angle for directing thereof generally towards the second edge as first reflected light, wherein the first deflection angle is less than the light switching angle, and
the second edge is positioned for turning, in the presence of the carrier injection, the first reflected light by a second deflection angle towards the second output waveguide for forming the switched light, wherein the second angle is less than the light switching angle.

3. An optical switch of claim 2, wherein a sum of the first deflection angle and the second deflection angle is equal to the light switching angle.

4. An optical switch of claim 3, wherein each of the first and second deflection angles is equal to a half of the light switching angle.

5. An optical switch of claim 1, wherein the electrode has a first edge facing the first input waveguide and a second edge, and wherein at least a central portion of the first edge is oriented at a grazing angle to the first input waveguide that is equal to one quarter of the light switching angle.

6. An optical switch of claim 1, wherein in the absence of the carrier injection, most of the input light passes under the first edge of the electrode.

7. An optical switch of claim 4, wherein in the absence of the carrier injection, more than 80% of the input light passes under the first edge of the electrode.

8. An optical switch of claim 2, wherein the first edge is oriented relative to the second edge at an electrode edge angle θₑ that is equal or less than one half of the waveguide switch angle θ.

9. An optical switch of claim 2, wherein each of the first and second edges are substantially straight.

10. An optical switch of claim 2, wherein at least one of the first and second edges is curved.

11. An optical switch of claim 8 wherein at least one of the first and second edges is curved, and wherein the electrode edge angle θₑ is an acute angle between tangents to the first and second edges at points of reflection of a central ray of the first input light and the first reflected light.

12. An optical switch of claim 1, wherein the substrate comprises a semiconductor material.

13. An optical switch of claim 12, wherein the substrate comprises an optical waveguide layer formed upon the substrate and in which the optical waveguide structure is formed.

14. An optical switch of claim 13, further comprising a second electrode disposed for passing electrical current between the switching electrode and the second electrode through a portion of the waveguide layer under the switching electrode for increasing a carrier concentration therein.

15. An optical switch of claim 13, wherein the waveguide structure is defined by ridges of a semiconductor material formed upon the waveguide layer, further comprising current restricting gaps formed along the first and second edges of the switching electrode in the waveguide branching regions.

16. An optical switch of claim 1, further comprising a second input waveguide that is optically aligned with the second output waveguide, wherein the switching electrode is shaped so that, when the input light is received in the second input waveguide in the presence of the carrier injection, most of the input light experiences multiple reflections in the waveguide branching region prior to being directed into the first output waveguide.
